(19) United States
(12) Patent Application Publication
(10) Pub. No.: US 2020/0027000 A1
(43) Pub. Date: Jan. 23, 2020

(54) METHODS AND SYSTEMS FOR ANNOTATING REGULATORY REGIONS OF A MICROBIAL GENOME

(71) Applicant: Samsung Electronics Co., Ltd., Suwon-si (KR)

(72) Inventors: Priyadarshini Panemangalore PAI, Bangalore (IN); Rajasekhara Reddy DUVVURU MUNI, Bangalore (IN); Taeyong KIM, Daejeon (KR)

(21) Appl. No.: 16/518,750

(22) Filed: Jul. 22, 2019

(30) Foreign Application Priority Data
Jul. 23, 2018 (IN) 201841027524
Jul. 11, 2019 (KR) 10-2019-0083946

(51) Int. Cl. G06N 3/08; G06F 16/14; G06N 5/02

(52) U.S. Cl. CPC G06N 3/08; G06N 5/02; G06F 16/148

(57) ABSTRACT

Methods and systems for annotating regulatory regions of a microbial genome. A method disclosed herein includes extracting data related to at least one promoter of the regulatory regions of the microbial genome, wherein the data includes at least one promoter sequence and data available for at least one promoter subtype. Based on extracted at least one feature of the at least one promoter sequence, the method further includes configuring at least one predictive model using the deep learning based neural network to predict the at least one promoter subtype associated with the at least one promoter sequence. The method further includes annotating at least one unknown promoter sequence into the at least one promoter subtype using the at least one configured predictive model.

### CROSS REFERENCE TO RELATED APPLICATION

This application claims the benefit of and priority to Indian Provisional Application 201841027524 as filed on Jul. 23, 2018, Indian Patent Application 201841027524 as filed on Mar. 5, 2019, and Korea Patent Application No. 10-2019-0083946 as filed on Jul. 11, 2019, the disclosures of which are incorporated by reference herein in their entireties.

### BACKGROUND

### 1. Field

The present disclosure relates to the field of genome engineering and more particularly to predicting regulatory regions of a microbial genome based on at least one automatically extracted feature.

### 2. Description of the Related Art

Microorganisms can be used in chemical factories/industries, agriculture, healthcare, environment protection domains and so on for synthesizing or degrading compounds. Unfortunately, only few of these microorganisms can thrive and perform their function in non-natural conditions. In order to facilitate the growth and productivity of naturally existing microorganisms in non-natural conditions, scientists often biotechnologically manipulate, that is, engineer microbial genomes. Such engineering efforts require identification of functional components in the microbial genomes including the genic and regulatory regions.

A genome is the genetic material of organisms, which can be made up of nucleic acids such as deoxyribonucleic acids (DNA) or ribonucleic acids (RNA). The genome of an organism includes protein coding regions (genes) and non-coding regions/regulatory regions (including elements responsible for transcriptional regulation, translational regulation, origin of replication etc), altogether forming a basis of their life processes. The non-coding regions of the genome include a specialized component called promoter, which can be responsible for gene expression initiation and regulation. The promoters of certain microorganisms can be classified into various subtypes depending on an initiation factor called a sigma factor. Different types of sigma factors (sigma (σ) 24, σ28, σ32, σ38, σ54, σ70 and so on) are required for different genes of the genome and environmental signals.

Since the regulatory regions govern the desirable activities of the genome, the identification of the regulatory regions is a crucial step in a genome annotation pipeline for facilitating downstream engineering and applications. Further, the promoters of the regulatory regions present a degree of consensus in their composition, but similar consensus is not observed among the various known subtypes. Therefore, elaborate experimental studies have to be performed for the identification of promoters and their subtypes, which can be cumbersome and resource intensive. To enable rapid identification of the promoters, several computational approaches have been developed. However, conventional computational approaches face limitations in terms of accessibility, applicability for all subtypes, use of local DNA-specific features and prediction accuracies achievable in real-time applications and so on.

### SUMMARY

The principal object of the embodiments herein is to disclose methods and systems for annotating regulatory regions of a microbial genome based on at least one automatically extracted sequence feature, wherein the regulatory regions include promoter sequence(s).

Another object of the embodiments herein is to disclose methods and systems for configuring at least one predictive model to predict promoter subtypes associated with the promoter sequence(s).

Another object of the embodiments herein is to disclose methods and systems for configuring the at least one predictive model based on features extracted from the promoter sequence(s) using a deep learning based neural network architecture.

Another object of the embodiments herein is to disclose methods and systems for using the configured at least one predictive model to characterize an unknown promoter sequence into at least one promoter subtype.

Additional aspects will be set forth in part in the description which follows and, in part, will be apparent from the description, or may be learned by practice of the presented embodiments of the disclosure.

Accordingly, the embodiments herein provide methods and systems for annotating regulatory regions of a microbial genome. A method disclosed herein includes extracting data related to at least one promoter of the regulatory regions of the microbial genome, wherein the data includes at least one promoter sequence and data available for at least one promoter subtype. The method further includes extracting at least one feature of the at least one promoter sequence using a deep learning based neural network. The method further includes configuring at least one predictive model based on the extracted at least one feature to predict the at least one promoter subtype associated with the at least one promoter sequence, wherein the at least one promoter subtype is a sigma factor based promoter subtype and the at least one predictive model is configured using the deep learning based neural network. The method further includes annotating at least one unknown promoter sequence into the at least one promoter subtype using the at least one configured predictive model.

Accordingly, embodiments herein provide an electronic device including a memory and an annotating engine coupled to the memory. The annotating engine comprises a data extraction module configured for extracting data related to at least one promoter of the regulatory regions of the microbial genome, wherein the data includes at least one promoter sequence and data available for at least one promoter subtype. The annotating engine further comprises a predictive model generation module configured for extracting at least one feature of the at least one promoter sequence using a deep learning based neural network. The predictive model generation module is further configured for configuring at least one predictive model based on the extracted at least one feature to predict the at least one promoter subtype associated with the at least one promoter sequence, wherein the at least one promoter subtype is a sigma factor based promoter subtype and the at least one predictive model is configured using the deep learning based neural network. The annotating engine further comprises a subtype prediction module configured for annotating at least one unknown promoter sequence into the at least one promoter subtype using the at least one configured predictive model.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF THE DRAWINGS

The above and other aspects, features, and advantages of certain embodiments of the disclosure will be more apparent from the following description taken in conjunction with the accompanying drawings.

Embodiments herein are illustrated in the accompanying drawings, throughout which like reference characters of the description indicate corresponding parts in the various figures.

FIG. 1 illustrates an electronic device for annotating regulatory regions of microbial genome, according to embodiments as disclosed herein;

FIG. 2 is a block diagram illustrating various modules of an annotating engine, according to embodiments as disclosed herein;

FIG. 3 is a flow diagram illustrating a method for annotating regulatory regions of a microbial genome, according to embodiments as disclosed herein;

FIG. 4 is a flow diagram illustrating a method for configuring at least one predictive model, according to embodiments as disclosed herein;

FIG. 5 is an example diagram illustrating extraction of data and preparation of dataset for configuring at least one predictive model, according to embodiments as disclosed herein;

FIG. 6 is an example diagram illustrating configuration of at least one predictive model and prediction of an unknown promoter sequence using the at least one predictive model, according to embodiments as disclosed herein; and

FIG. 7 is an example table illustrating comparative analysis of model accuracies of at least one predictive model configured using a deep learning based neural network with conventional approaches, according to embodiments as disclosed herein.

### DETAILED DESCRIPTION

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

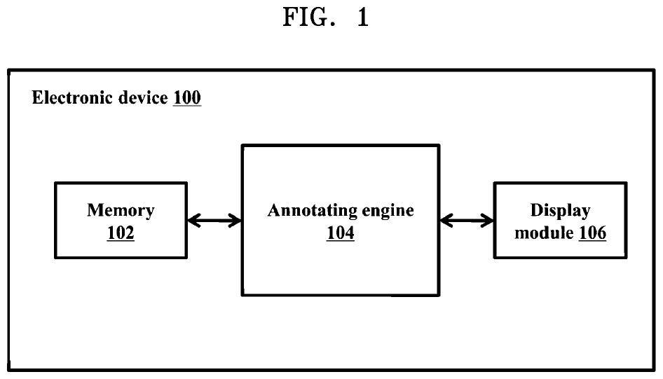

Embodiments herein disclose methods and systems for annotating regulatory regions of a microbial genome based on at least one automatically extracted sequence feature. Referring now to the drawings, and more particularly to FIGS. 1 through 7, where similar reference characters denote corresponding features consistently throughout the figures, there are shown example embodiments.

FIG. 1 illustrates an electronic device 100 for annotating regulatory regions of microbial genome(s), according to embodiments as disclosed herein. The microbial genome can comprise genetic information of a microorganism including deoxyribonucleic acid (DNA) or ribonucleic acid (RNA). Examples of the microorganism can be, but is not limited to, bacteria, archaea, viruses or the like. Embodiments herein are further explained considering bacterial genome as an example of the microbial genome, but it may be understood by a person of ordinary skill in the art that any other microbial genomes can be considered. The microbial genome contains information needed to build and maintain the microorganism. Further, the microbial genome includes regulatory regions such as, but not limited to, promoters or the like. The promoters can be complexly encoded with a wide range of variation in a degree of sequence conservation, functional site location and natural response to environmental signals. The promoters can be responsible for the binding of a RNA polymerase to the DNA for catalyzing gene expression into desirable products. Selection of the promoters by RNA polymerase depends on an initiation factor called a sigma factor. Further, the promoters can be classified into a plurality of promoter subtypes based on the sigma factor. In an example herein, an Escherichia coli promoter may be classified into the subtypes of sigma σ24, σ28, σ32, σ38, σ54, σ70 and so on.

The electronic device 100 referred herein can be a computing device on which a neural network model can be built and deployed to annotate the regulatory regions of the microbial genome. In an embodiment herein, the network model can be a Convolutional Neural Network (CNN) model. Examples of the electronic device 100 can be, but is not limited to, a mobile phone, a smart phone, a tablet, a handheld device, a phablet, a laptop, a computer, a wearable computing device, a medical equipment, an Internet of Things (IoT) device and so on. The electronic device 100 includes a memory 102, an annotating engine 104 and a display module 106. The electronic device 100 may be connected to a server and at least one external database (not shown) using a communication network for accessing information/data related to the microbial genome. Examples of the communication network can be, but is not limited to, the Internet, a wired network (a Local Area Network (LAN), Ethernet and so on), a wireless network (a Wi-Fi network, a cellular network, a Wi-Fi Hotspot, Bluetooth, Zigbee and so on) and so on. In an embodiment, the electronic device 100 can be deployed as the server. The server can be, but is not limited to, a standalone server, a server on a cloud and so on. In another embodiment, the electronic device 100 can be a cloud computing system or can be connected to a cloud computing platform/system. Also, the cloud computing platform/system such as the electronic device 100 can be connected to user devices located in different geographical locations using the communication network.

The memory 102 can store information/dataset related to the microbial genomes, outputs/predictions of the annotator engine 104 and so on. The memory 102 may include one or more computer-readable storage media. The memory 102 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 102 may, in some examples, be considered a non-transitory storage medium. The term “non-transitory” may indicate that the storage medium is not embodied in a carrier wave or a propagated signal. However, the term “non-transitory” should not be interpreted to mean that the memory 102 is non-movable. In some examples, the memory 102 can be configured to store larger amounts of information than the memory. In certain examples, a non-transitory storage medium may store data that can, over time, change (e.g., in Random Access Memory (RAM) or cache).

The annotating engine 104 can comprise of at least one of a single processor, a plurality of processors, multiple homogenous cores, multiple heterogeneous cores, multiple Central Processing Unit (CPUs) of different kinds and so on. The annotating engine 104 can be configured for annotating the regulatory regions of the microbial genome. Annotating the regulatory regions involves building predictive model(s) based on at least one automatically extracted sequence feature and characterizing an unknown promoter of the regulatory regions into at least one promoter subtype using the predictive model(s). The predictive model can be at least one of a binary classification model and a multi-class classification model. Thus, the annotating engine 104 can annotate the regulatory regions without requiring any extraction of specific rules, consensus and so on.

The display module 106 can be configured to receive a query from the user for predicting the unknown promoter. The display unit 106 can be further configured to display the predicted at least one promoter subtype for the unknown promoter.

FIG. 1 shows exemplary units of the electronic device 100, but it is to be understood that other embodiments are not limited thereon. In other embodiments, the electronic device 100 may include less or more number of units. Further, the labels or names of the units are used only for illustrative purpose and does not limit the scope of the embodiments herein. One or more units can be combined together to perform same or substantially similar function in the electronic device 100.

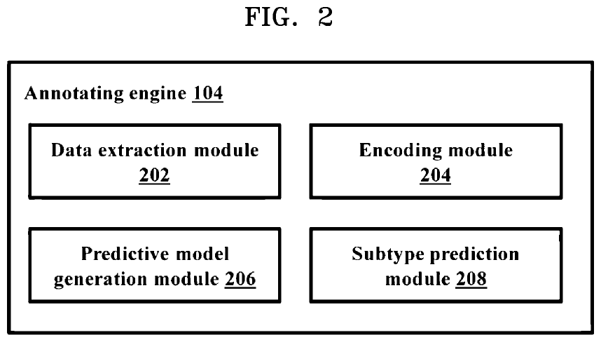

FIG. 2 is a block diagram illustrating various modules of the annotating engine 104, according to embodiments as disclosed herein. The annotating engine 104 includes a data extraction module 202, an encoding module 204, a predictive model generation module 206 and a subtype prediction module 208.

The data extraction module 202 can be configured to extract the data related to the promoters of the regulatory regions of the microbial genome. The data extractor module 202 can extract the data from at least one of the memory 102 and the external databases. The data extraction module 202 can apply filters on the extracted data to obtain the promoter data with the promoter subtypes details. The filters can be data source filters, which can be applied to obtain the promoter data by filtering data other than the promoter data. The data extraction module 202 can further group the promoter sequence(s) belonging each of the promoter subtypes. Further, the promoter sequence can be a nucleotide sequence. Embodiments herein use the terms “promoters”, “promoter regions”, “promoter sequences’ ‘nucleotide sequence’ and so on interchangeably to refer to a portion of DNA lying upstream of a coding region containing binding sites for the RNA polymerase to initiate gene transcription. The data extraction module 202 further prepares a dataset from the available data (for the promoter subtypes) which is required to configure the predictive model. In an example herein, the data extraction module 202 prepares 6 datasets for configuring 6 binary classification models, wherein a dataset can be prepared for each sigma based subtype. For every subtype, all the representative promoters of that subtype are considered (positive class for the subtype) along with equal/maximum number of representatives of promoters other than this subtype. In another example herein, the data extraction module 202 prepares one dataset comprising of all promoters representative of all the included six subtypes.

In an example herein, the data extraction module 202 may extract/collect the data related to promoter sequence(s) of an Escherichia coli (the bacteria) from web resources using the communication network. The data extraction module 202 provides the extracted promoter sequence to the encoding module 204 and the prepared dataset to the predictive model generation module 206.

The encoding module 204 can be configured to encode the extracted promoter sequence into binary vectors. In an embodiment, the encoding module 204 uses a one-hot encoding scheme to encode the extracted/possible promoter sequence/putative promoter into one-hot vectors.

In accordance with the one-hot encoding scheme, the encoding module 204 performs an integer encoding on the string of the promoter sequence. Performing the integer encoding involves creating a mapping of all possible inputs from the characters of the promoter nucleotide sequence to the integer values. Thereafter, the encoding module 204 converts the integer encoding into one-hot encoding by converting one integer encoded character at a time. Conversion of the integer encoding into the one-hot encoding involves providing a list of ‘0’ (zero) values creating a length of the character so that any character can be represented using a one-hot code vector. Further, the encoding module 204 determines a position/index of the characters in the promoter sequence and marks the index/position of the characters as ‘1’. Thereafter, the encoding module 204 inverts the encoding of the characters to produce numerical/binary vectors for the characters by locating the position of the characters in the promoter sequence and using the integer in a reverse look table of character values to the integer values. In an example herein, ‘a’ can be encoded numerically as 0, can be encoded as ‘1’, ‘g’ can be encoded as ‘2’ and ‘c’ can be encoded as ‘3’. Thereafter, the encoding of the characters can be converted into the one-hot vectors. For example, ‘a’ can be represented as “1000” and can be represented as “0100”.

In an example, a promoter sequence of 81 nucleotides extracted by the data extraction module 202 can be encoded by the encoding module 204 to provide a one-hot encoded vector/matrix of 81×4 dimensions, which are further used by the predictive model generation module 206 for configuring the predictive model(s).

The predictive model generation module 206 can be configured to build/configure the predictive model(s) for predicting and classification of the promoter sequence. The predictive model can be at least one of the binary classification model, the multiclass classification model and so on. The predictive model generation module 206 receives the data available for the promoter subtype from the data extraction module 202 and the encoded promoter sequence from the encoding module 204. The predictive model generation module 206 uses the data including the positive and negative examples for building the binary classification model.

In an embodiment, the predictive model generation module 206 uses a deep learning approach of the neural network to configure the predictive model(s). In an embodiment, the predictive model generation module 206 uses a sequential model for deep learning to configure the predictive model(s). The sequential model can include a series of functional layers that can be designed for deep learning. In an embodiment, the sequential model includes a one-dimensional (1D) convolutional layer, a pooling layer, a flatten layer, dense layers/fully connected layers with dropout and a final output layer. The sequential model can be compiled using optimizers such as, but not limited to, an Adam optimizer or the like. Further embodiments herein can use categorical/binary cross-entropy loss functions and accuracy metric to select best performing sequential models. It should be noted that the embodiments disclosed herein may use any other loss functions and performance assessment parameters while configuring the predictive model(s).

Embodiments herein are further explained using a Convolutional Neural Network (CNN) as an example of the sequential model for configuring the predictive model, but it may be understood by a person of ordinary skill in the art that any suitable deep learning based neural network can be used. The predictive model generation module 206 provides the encoded promoter sequence (the one-hot vectors of the promoter sequence) and the data available for the promoter subtypes as inputs to the CNN. The CNN creates/configures the predictive model using functional layers such as, but not limited to, a 1D convolutional layer with a plurality of 1D convolution filters, a pooling layer, a flatten layer, dense fully connected layers and a final output layer. In an example herein, two fully connected layers can be used for configuring the predictive model.

Embodiments herein are further explained using a one-dimensional (1D) convolutional layer with a plurality of 1D convolution filters as an example of a functional layer, but it may be obvious to a person of ordinary skill in the art that any suitable predictive layer can be used. The 1D convolutional layer receives and processes the encoded promoter sequence to extract features of the promoter sequence. On receiving the encoded promoter sequence (the one-hot vectors of the promoter sequence), the 1D convolution layer performs a convolution operation on the one-hot vectors across the 1D convolution filters to extract the features of the promoter sequence. The convolution operation includes performing multiplication of the one-hot vectors with kernel data (selected filters across 4 channels) and accumulating the results of the multiplications to generate an output feature map. The output feature map can be a two-dimensional (2D) array/2D matrix representing the features of the promoter sequence. In an embodiment, the 1D convolution layer performs a convolution operation based on pre-defined parameters. The parameters can be, but not limited to, a filter size, a number of filters, a kernel size, strides, padding, a data-format, a dilation rate, a depth multiplier, an activation function, a use bias, point wise initializer, depthwise initializer, depthwiseregularizer, pointwise regularizer, bias regularizer, an activity regularizer, a depthwise constraint, a pointwise constraint, a bias constraint and so on. The 1D convolutional layer provides the extracted features/output feature map to the pooling layer.

The pooling layer can be configured for reducing dimension of the extracted features, which further reduces computational complexity for successive layers (the fully connected layer. In an embodiment herein, the pooling layer may use a max pooling function to reduce the dimension of the extracted features. Embodiments herein may further enable the pooling layer to use functions such as, but not limited to, a max pooling function, an average pooling function, a global max pooling function and so on for reducing the dimension of the extracted features. The pooling layer provides the pooled promoter sequence to the flatten layer. The pooled promoter sequence can be a 2D array/2D matrix.

The flatten layer can be configured for transforming the pooled extracted features (the entire pooled feature map matrix) into a single column matrix. The flatten layer provides the flattened extracted features (the single column matrix) to the fully connected layers.

The fully connected layers can be configured to learn how to use the extracted features from the single column matrix to classify the promoter sequence into the at least one promoter subtype. The fully connected layers are hidden layers/dense layers that can use “Rectified Linear Unit” (relu) activation or the like. In an embodiment herein, two fully connected or hidden layers may be used comprising of a plurality of hidden units. The relu activation of the hidden layers can be computed by performing a multiplication of the singe column matrix with added bias offsets. In an embodiment, a plurality of hidden units may be dropped in the first fully connected layer. In an embodiment, the dropout can be performed by selecting the hidden units randomly. In another embodiment, the hidden units retained with a probability p, which can be independent of other hidden units, can be selected for performing the dropout. Further, performing the dropout amounts to sampling a thinned network from the CNN/deep learning based neural network. The thinned network may consist of the hidden units that survived from the dropout. Thus, performing the dropout of the hidden units at the fully connected layers may reduce the overfitting issues. The dropout can be performed based on factors such as, but not limited to, a neural network size, a learning rate and momentum max-norm regularization, a dropout rate and so on. The fully connected layers provide the features after performing the dropout to the final output layer.

The final output layer can be configured to classify the promoter sequence into the at least one promoter subtype (based on the sigma factor) by configuring the predictive model. The final output layer receives the features from the fully connected layers after performing the dropouts and uses a “Softmax” function to classify the promoter sequence by generating probability for the feature.

In an embodiment, based on the classification performed by the “Softmax” function, the fully connected layers can select a single promoter subtype for configuring the binary classification model corresponding to the selected promoter subtype. Thus, the binary classification model can predict whether a given promoter sequence belongs to a specific promoter subtype or not. In an example herein, the binary classification model corresponding to a promoter subtype of σ24 can predict whether the given promoter sequence can belong to σ24 or not.

In another embodiment, based on the classification performed by the “Softmax” function, the fully connected layers consider the plurality of promoter subtypes for configuring the multiclass classification model. Thus, the multiclass classification model can predict the at least one promoter subtype for the given promoter sequence. In an example herein, the multiclass classification model can predict that the given promoter sequence can belong to the promoter subtype of σ24, σ28 and so on with specific probabilities/the probabilities of a given query sequence in each of subtypes.

In an embodiment, the predictive model generation module 206 can tune pre-defined parameters associated with the predictive layers of the CNN to configure the predictive model. Examples of the parameters can be, but not limited to, filter size, number of filters, pool size, dropout rate and so on. Thus, configuring the predictive model using the CNN circumvents a need for manual feature engineering. In addition, configuring the predictive model using the CNN eliminates a need for rule extraction procedures and for insertion of hypothetical examples.

The subtype prediction module 208 can be configured for predicting the promoter subtypes for an unknown promoter sequence using the configured predictive model. The subtype prediction module 208 receives a query from the user for predicting the promoter subtype. The received query can include at least one of an unknown promoter sequence, a GenBank record file and so on.

If the received query includes the GenBank file, the subtype prediction module 208 extracts a summary from the GenBankfile, which includes information about at least one of plus strand genes, minus strand genes, potential operons, overlapping genes and so on. Further, the subtype prediction module 208 extracts information about the gene and inter-genic regions of the genome sequence from the GenBankfile and extracts subsequences from the inter-genic regions. The subtype prediction module 208 further identifies the unknown promoter sequence from the subsequences extracted from the GenBank file. In an example herein, the subtype prediction module receives the GenBank file including information about gene positions. On receiving the GenBank file, the subtype prediction module 208 considers 81 nucleotides upstream of start positions as candidates for promoter prediction when boundaries of the genes are clear and an inter-genic distance is greater than 100 nucleotides.

The subtype prediction module 208 further passes the identified unknown promoter sequence to the configured predictive model which can characterize the unknown promoter sequence into the at least one promoter subtype.

If the query received from the user includes the unknown promoter sequence, the subtype prediction module 208 directly passes the unknown promoter sequence to the configured predictive model. The configured predictive model characterizes the unknown promoter sequence into at least one promoter subtype.

In an embodiment, the subtype prediction module 208 selects at least one of the binary classification model and/or the multiclass classification model to predict the unknown promoter sequence. The at least one of the binary classification model and the multiclass classification model can be selected based on a nature of the query. If the query received from the user is for predicting the specific promoter subtype, then the subtype prediction module 208 selects the binary classification model to predict the promoter subtype. Further, the subtype prediction module 208 can use ‘n’ number of binary classification models to predict ‘n’ number of promoter subtypes for the unknown promoter sequence. In an example herein ‘n’ can be 1-6. For example, the subtype prediction module 208 can use six binary classification models to predict six promoter subtypes for the unknown promoter sequence. Consider an example scenario, wherein the user wants to know whether the unknown promoter sequence belongs to a promoter subtype of σ24 and σ28, then the subtype prediction module 208 uses 2 binary classification models for predicting the promoter subtypes of σ24 and σ28. In an example herein, a first binary classification model can predict whether the unknown promoter sequence belongs to the promoter subtype of σ24 or not. A second binary classification model can predict whether the unknown promoter sequence belongs to the promoter subtype of σ28 or not.

If the query received from the user is to predict the at least one promoter subtype of the plurality of subtypes, then the subtype prediction module 208 uses the multiclass classification model to predict the unknown promoter sequence. Consider an example scenario, wherein the user wants to know about the promoter subtypes associated with the unknown promoter sequence and the unknown promoter sequence can belong to any of the promoter subtypes of σ24, σ28, σ32, σ38, σ54 and σ70. The subtype prediction module 208 uses the multiclass classification model to predict whether the unknown promoter sequence belongs to the promoter subtypes of at least one of σ24, σ28, σ32, σ38, σ54 and σ70. In an example herein, the subtype prediction module 208 can predict that the unknown sequence can belong to the promoter subtype of σ24.

FIG. 2 shows exemplary units of the annotating engine 104, but it is to be understood that other embodiments are not limited thereon. In other embodiments, the annotating engine 104 may include less or more number of units. Further, the labels or names of the units are used only for illustrative purpose and does not limit the scope of the embodiments herein. One or more units can be combined together to perform same or substantially similar function in the annotating engine 104.

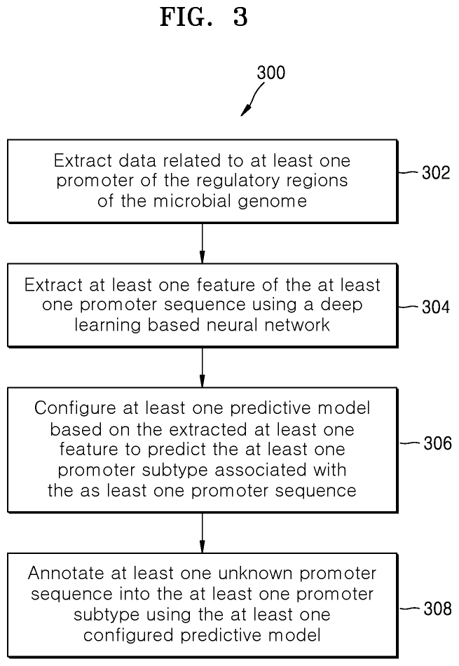

FIG. 3 is a flow diagram 300 illustrating a method for annotating the regulatory regions of the microbial genome, according to embodiments as disclosed herein.

At step 302, the method includes extracting, e.g. by the annotating engine 104, the data related to the promoter(s) of the regulatory regions of the microbial genome. The data includes the promoter sequence(s) and the data available for the promoter subtypes.

At step 304, the method includes extracting, e.g. by the annotating engine 104, the features of the promoter sequence using the deep learning based neural network. The annotating engine 104 encodes the promoter sequence into the one-hot vectors using the one-hot encoding scheme. The annotating engine 104 further performs convolution operation on the encoded one-hot vectors using the convolutional layer of the deep learning based neural network for extracting the features of the promoter sequence. The convolutional operation involves multiplication of the encoded promoter sequence with the kernel data and accumulation of results of the multiplication to form the output feature map. The convolutional layer uses a plurality of 1D convolution filters to extract the features of the promoter sequence.

At step 306, the method includes configuring, e.g. by the annotating engine 104, the at least one predictive model based on the extracted features to predict the at least one promoter subtype associated with the promoter sequence. The promoter subtype can be a sigma factor based promoter subtype. The annotating engine 104 configures the at least one predictive model using the deep learning based neural network.

At step 308, the method includes annotating, e.g. by the annotating engine 104, the unknown promoter sequence into the at least one promoter subtype using the at least one configured predictive model. The annotating engine 104 receives the query from the user to predict the unknown promoter sequence. In an embodiment, the query can include the unknown promoter sequence. The annotating engine 104 directly passes the query including the unknown promoter sequence to the predictive model, which predicts the promoter subtype for the unknown promoter sequence. In another embodiment, the query can include the GenBank file. The annotating engine 104 extracts the subsequences and the genome summary from the GenBank file. The annotating engine 104 further identifies the unknown promoter sequence(s) from the subsequences and passes to the predictive model, which predicts the promoter subtype for the unknown promoter sequence. In an embodiment, for predicting the unknown promoter sequence, the annotating engine 104 selects the at least one of the binary classification model and the multiclass classification model based on the nature of the query. If the query received from the user specifies any promoter subtype, then the annotating engine 104 uses the binary classification model to predict whether the unknown promoter sequence belongs to the specified promoter subtype or not. If the query received from the user does not specify any promoter subtype, then the annotating engine 104 uses the multiclass classification model to predict the at least one promoter subtype for the unknown promoter sequence.

The various actions, acts, blocks, steps, or the like in the method and the flow diagram 300 may be performed in the order presented, in a different order or simultaneously. Further, in some embodiments, some of the actions, acts, blocks, steps, or the like may be omitted, added, modified, skipped, or the like without departing from the scope of the invention.

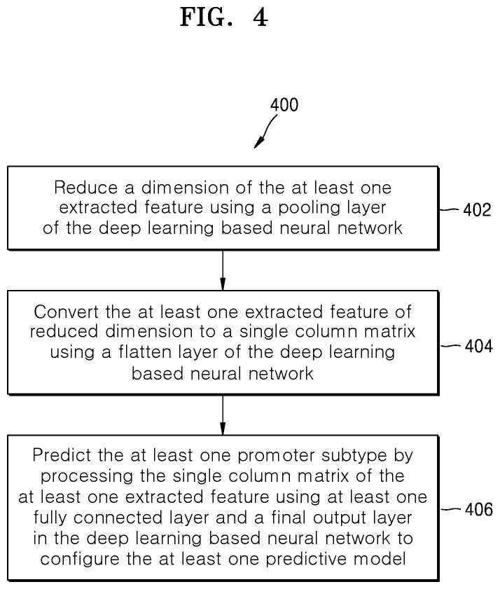

FIG. 4 is a flow diagram illustrating a method for configuring the at least one predictive model, according to embodiments as disclosed herein.

At step 402, the method includes reducing, e.g. by the annotating engine 104, the dimensions of the extracted features using a pooling layer of the deep learning based neural network. The pooling layer performs the down sampling function along spatial dimensions (height, width) of the extracted features to reduce the depth/volume dimensions of the extracted feature.

At step 404, the method includes converting, e.g. by the annotating engine 104, the extracted features of reduced dimension to the single column matrix using the flatten layer of the deep learning based neural network.

At step 406, the method includes predicting, e.g. by the annotating engine 104, the at least one promoter subtype by processing the single column matrix of the extracted features using the fully connected layers and the final output layer in the deep learning based neural network to configure the at least one predictive model. The fully connected layers include the hidden layers/dense layers that can use Rectified Linear Unit (relu) activation or the like. The hidden layers may comprise the plurality of hidden units/neurons. The fully connected layers may perform the dropout of the hidden units. In an embodiment, the dropout can be performed by selecting the hidden units randomly. In another embodiment, the hidden units retained with a probability p, which can be independent of other hidden units, can be selected for performing the dropout. Thus, performing the dropout of the hidden units at the fully connected layers may reduce the overfitting issues. After performing the dropout, the fully connected layers provide the extracted features to the final output layer. The final output layer can be configured to classify the promoter sequence into the at least one promoter subtype (based on the sigma factor) by configuring the predictive model based on the extracted features. The final output layer uses the “Softmax” function to classify the promoter sequence. Based on the classification performed by the final output layer, the at least one of the binary classification model and the multiclass classification model can be configured. The binary classification model predicts whether a given promoter sequence belongs to the at least one promoter subtype or not. The multiclass classification model predicts the at least one promoter subtype for the given promoter sequence. In an embodiment, the annotating engine 104 can perform a hyper-parameter optimization to configure the predictive model. The hyper-parameter optimization involves tuning the parameters (such as filter size, number of filters, pool size, dropout rate and so on) of the predictive layers of the deep learning based neural network to configure the predictive model.

The various actions, acts, blocks, steps, or the like in the method and the flow diagram 400 may be performed in the order presented, in a different order or simultaneously. Further, in some embodiments, some of the actions, acts, blocks, steps, or the like may be omitted, added, modified, skipped, or the like without departing from the scope of the invention.

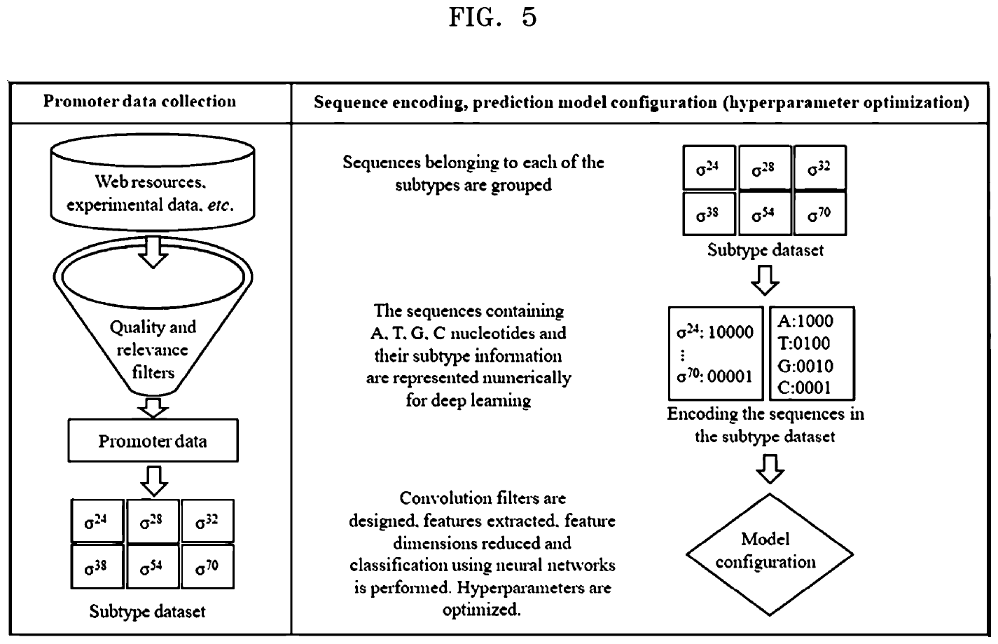

FIG. 5 is an example diagram illustrating extraction of data and preparation of dataset for configuring the predictive model, according to embodiments as disclosed herein. Embodiments herein enable the annotating engine 104, for example, to extract the data related to the promoters of the regulatory regions of the microbial genome from at least one of web resources/servers, experimental data and so on. After extraction of the data, the annotating engine 104 applies quality and relevance filters and obtains promoter data with the subtype details. In an example herein, the sequence information for six sigma based promoter subtypes such as, σ24, σ28, σ32, σ38, σ54 and σ70 can be obtained. Embodiments herein explained obtaining of the six sigma based subtypes such as σ24, σ28, σ32, σ38, σ54 and σ70 using the data related to the promoters, but it may be understood by a person of ordinary skill in the art that any other sigma based subtypes (σ19 or the like) can be obtained from the data related to the promoters.

After obtaining the promoter data with the promoter subtypes details, the annotating engine 104 can perform a grouping of the promoter sequences belonging to each of the obtained promoter subtypes. Thereafter, the annotating engine 104 encodes the promoter sequences in the subtype dataset using the one-hot encoding scheme. In an example herein, the promoter sequences containing ‘A’, ‘T’, ‘G’, and ‘C’ nucleotides and their subtype details can be represented numerically using the one-hot encoding scheme for deep learning.

The annotating engine 104 further passes the encoded promoter sequences to the deep learning based neural network for configuring the predictive model. The predictive model can be configured by extracting the features, reducing the dimensions of the extracted features and classifying the extracted features using the deep learning based neural network. In an embodiment, the annotating engine 104 performs hyper-parameter optimization and performance assessment for building the predictive model(s). The hyper-parameter optimization and performance assessment includes tuning of the parameters associated with the prediction layers of the CNN to build the predictive model(s).

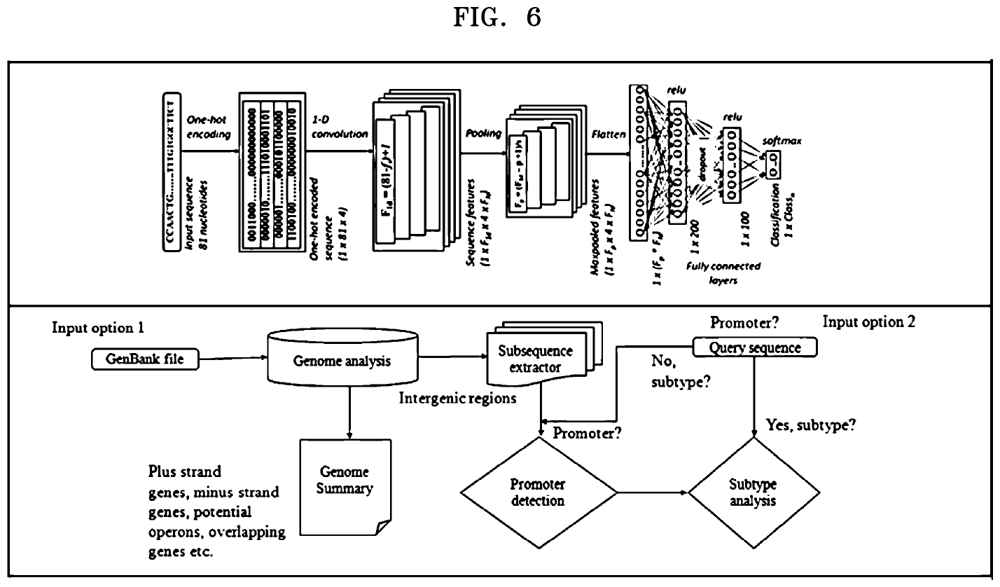

FIG. 6 is an example diagram illustrating configuration of the at least one predictive model and prediction of the unknown promoter sequence using the at least one predictive model, according to embodiments as disclosed herein.

The annotating engine 104 passes the encoded promoter sequence to the convolutional layer of the CNN. The convolutional layer employs the plurality of 1D convolutional filters, which can convolve the one-hot encoded promoter sequence to extract a feature map. The feature map indicates the features automatically extracted from the promoter sequence. Further, the extracted features can be passed to the pooling layer that reduces the volume/dimensions of the extracted features. The extracted features with reduced volume/dimensions can be passed to the flatten layer that further represents the extracted features in a form of single column matrix and provides the single column matrix to the fully connected layers. The fully connected layers include the hidden layers comprising of the plurality of hidden units. Embodiments herein may enable the fully connected layers to dropout the hidden units in order to avoid the overfitting issues. The final output layer uses the “Softmax” function to build the at least one of the binary classification model and the multiclass classification model based on the automatically extracted features received from the fully connected layers. The binary classification model can identify/predict whether a given promoter sequence belongs to the at least one promoter subtype or not. For example, the binary classification model can identify whether the promoter sequence belongs to a promoter subtype of σ24 or not. The multiclass classification model can predict the at least one promoter subtype for a given promoter sequence. For example, the multiclass classification model can predict that the given promoter sequence can belong to the promoter subtype of σ28.

Embodiments herein enable the annotating engine 104 to use the at least one configured predictive model for predicting the unknown promoter sequence. The annotating engine 104 receives the input from the user for predicting the unknown promoter sequence. The input can be at least one of the GenBank file (an input option 1) and the query sequence (an input option 2).

On receiving the GenBank file, the annotating engine 104 extracts the genome summary and the subsequences from the inter-genic regions of the genome sequence. The extracted genome summary can include information about at least one of plus strand genes, minus strand genes, potential operons, overlapping genes and so on. The annotating engine 104 checks whether the extracted subsequences are the promoter sequences or not. On determining that the extracted subsequences are the promoter sequences, then the annotating engine 104 uses the at least one configured predictive model to perform subtype analysis for the extracted promoter sequences. The annotating engine 104 may select the at least one predictive model based on the nature of the query received from the user.

On receiving the query sequence from the user, the annotating engine 104 checks whether the received query sequence is the promoter sequence or not. On determining that the received query sequence is the promoter sequence, the annotating engine 104 uses the at least one configured predictive model to perform subtype analysis for the extracted promoter sequence.

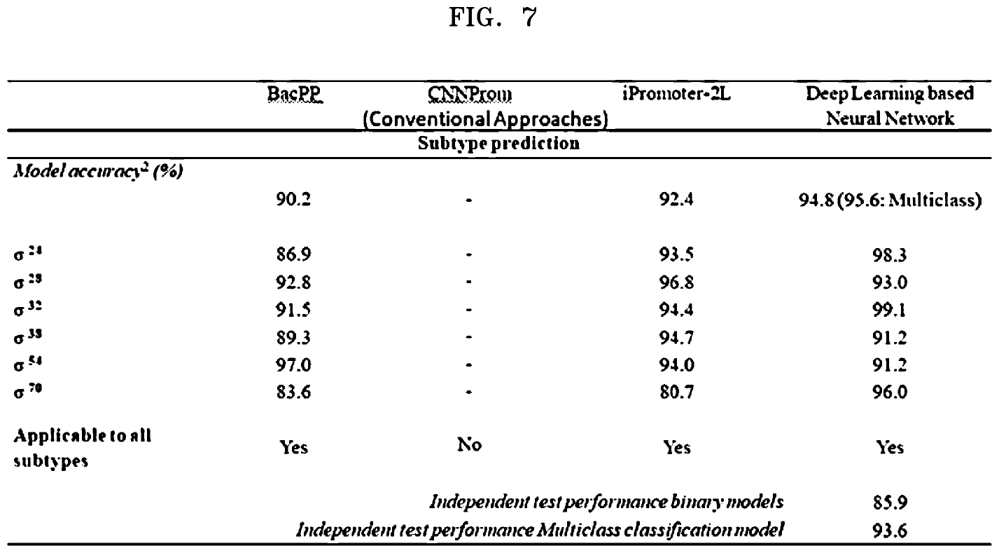

FIG. 7 is an example table illustrating comparative analysis of model accuracies of the predictive model configured using the deep learning based neural network with conventional approaches, according to embodiments as disclosed herein. In the conventional approaches, prediction of the promoter sequence requires a rule extraction, artificial data, consensus and so on.

In contrast, in order to predict the promoter sequence, embodiments herein enable the annotating engine 104 to build the predictive model (the binary classification model and the multiclass classification model) using the CNN. The CNN automatically extracts the features of the promoter sequence for building the predictive model(s). Thus, the prediction of the promoter sequence does not require the rule extraction, the artificial data and the manual feature engineering. In addition, the accuracies of the predictive models can be enhanced. In an example herein, the model accuracies of the binary classification models and the multiclass classification model corresponding to the 6 promoter subtypes and average model accuracies of the binary classification model and the multiclass classification model across the 6 promoter subtypes is illustrated in FIG. 7.

Embodiments herein facilitate rapid annotations of microbial genomes through prediction of promoter subtypes in a rule-free, homology/consensus independent architecture that can circumvent manual feature engineering. Embodiments herein predict the promoter subtypes based on automatic sequence feature extraction in a deep learning approach using a neural network.

The embodiments disclosed herein can be implemented through at least one software program (e.g. stored on non-transient computer-readable medium) running on at least one hardware device and performing network management functions to control the elements. The elements shown in FIG. 1 and FIG. 2 can be at least one of a hardware device, or a combination of hardware device and software module.

The embodiments disclosed herein describe methods and systems for annotating regulatory regions of a microbial genome. Therefore, it is understood that the scope of the protection is extended to such a program and in addition to a computer readable means, having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs and/or GPUs. Collectively, such hardware and/or software devices (whether in the singular or the plural sense), and associated functionality, for implementing embodiments of the disclosed devices, systems and methods for annotating regulatory regions of a microbial genome may be more simply referred to herein, and in the appended claims, as “processor.”

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

What is claimed is:

1. A method for annotating regulatory regions of a microbial genome, the method comprising;
extracting, by a processor, data related to at least one promoter of the regulatory regions of the microbial genome, wherein the data includes at least one promoter sequence and data available for at least one promoter subtype;
extracting, by the processor, at least one feature of the at least one promoter sequence using a deep learning based neural network;
configuring, by the processor, at least one predictive model based on the extracted at least one feature to predict the at least one promoter subtype associated with the at least one promoter sequence; and
annotating, by the processor, at least one unknown promoter sequence into the at least one promoter subtype using the at least one configured predictive model.

2. The method of claim 1, wherein the at least one promoter subtype is a sigma factor based promoter subtype and the at least one predictive model is configured using the deep learning based neural network.

3. The method of claim 1, wherein extracting the at least one feature of the at least one promoter sequence includes:
encoding the at least one promoter sequence into at least one one-hot vector using a one-hot encoding scheme; and
performing a convolution operation on the encoded at least one-hot vector using a convolutional layer of the deep learning based neural network to extract the at least one feature of the at least one promoter sequence.

4. The method of claim 1, wherein configuring the at least one predictive model includes:
reducing a dimension of the at least one extracted feature using a pooling layer of the deep learning based neural network;
converting the at least one extracted feature of reduced dimension to a single column matrix using a flatten layer of the deep learning based neural network; and
predicting the at least one promoter subtype by processing the single column matrix of the at least one extracted feature using at least one fully connected layer and a final output layer in the deep learning based neural network to configure the at least one predictive model.

5. The method of claim 4, further comprising performing, by the processor, rigorous dropouts of at least one hidden unit in the at least one fully connected layer.

6. The method of claim 4, wherein the at least one predictive model includes at least one of a binary classification model and a multiclass classification model.

7. The method of claim 1, further comprising tuning, by the processor, at least one parameter associated with at least one of the convolutional layer and the pooling layer of the deep learning based neural network to configure the at least one predictive model.

8. The method of claim 1, wherein annotating the at least one unknown promoter sequence includes:
receiving at least one query including an unknown promoter sequence of the microbial genome from a user; and
providing the query as an input to the at least one predictive model for predicting the at least one promoter subtype for the at least one unknown promoter sequence.

9. The method of claim 8, further comprising:
receiving at least one query from the user including a GenBank file of the microbial genome;
extracting at least one subsequence of the regulatory regions of the microbial genome from the GenBank file;
identifying the at least one unknown promoter sequence from the extracted at least one subsequence; and
providing the at least one unknown promoter sequence as the input to the at least one predictive model for predicting the at least one promoter subtype for the at least one unknown promoter sequence.

10. A method for annotating regulatory regions of a microbial genome, the method comprising:
configuring, by a processor, at least one predictive model based on an automatic feature extraction to predict at least one promoter subtype for at least one promoter sequence of the regulatory regions of the microbial genome, wherein the at least one promoter subtype is a sigma factor based promoter subtype.

11. The method of claim 10, wherein configuring the at least one predictive model includes:
extracting data related to at least one promoter of the regulatory regions of the microbial genome, wherein the data includes at least one promoter sequence and data available for at least one promoter subtype;
encoding the at least one promoter sequence into at least one one-hot vector using a one-hot encoding scheme;
extracting at least one feature related to the at least one promoter sequence using a convolutional layer of the deep learning based neural network, wherein the convolutional layer performs a convolution operation on the encoded at least one-hot vector to extract the at least one feature;
reducing a dimension of the at least one extracted feature using a pooling layer of the deep learning based neural network;
converting the at least one extracted feature of reduced dimension to a single column matrix using a flatten layer of the deep learning based neural network; and
predicting the at least one promoter subtype by processing the single column matrix of the at least one extracted feature using at least one fully connected layer and a final output layer in the deep learning based neural network to configure the at least one predictive model.

12. The method of claim 10, further comprising:
receiving, by the processor, at least one query from a user for predicting at least one unknown promoter subtype; and
using, by the processor, the at least one predictive model to predict the at least one promoter subtype for the at least one unknown promoter sequence.

13. An electronic device comprising:
a memory; and
a processor coupled to the memory, wherein the processor is configured to:
extract data related to at least one promoter of the regulatory regions of the microbial genome, wherein the data includes at least one promoter sequence and data available for at least one promoter subtype;
extract at least one feature of the at least one promoter sequence using a deep learning based neural network;
configure at least one predictive model based on the extracted at least one feature to predict the at least one promoter subtype associated with the at least one promoter sequence; and
annotate at least one unknown promoter sequence into the at least one promoter subtype using the at least one configured predictive model.

14. The electronic device of claim 13, wherein the at least one promoter subtype is a sigma factor based promoter subtype and the at least one predictive model is configured using the deep learning based neural network.

15. The electronic device of claim 13, wherein the processor is further configured to:
encode the at least one promoter sequence into at least one one-hot vector using a one-hot encoding scheme; and
perform a convolution operation on the encoded at least one-hot vector using a convolutional layer of the deep learning based neural network to extract the at least one feature of the at least one promoter sequence.

16. The electronic device of claim 13, wherein the processor is further configured to:
reduce a dimension of the at least one extracted feature using a pooling layer of the deep learning based neural network;
convert the at least one extracted feature of reduced dimension to a single column matrix using a flatten layer of the deep learning based neural network; and
predict the at least one promoter subtype by processing the single column matrix of the at least one extracted feature using at least one fully connected layer and a final output layer in the deep learning based neural network to configure the at least one predictive model.

17. The electronic device of claim 16, wherein the processor is further configured to perform dropouts of at least one hidden unit in the at least one fully connected layer.

18. The electronic device of claim 13, wherein the processor is further configured to tune at least one parameter associated with at least one of the convolutional layer and the pooling layer of the deep learning based neural network to configure the at least one predictive model.

19. The electronic device of claim 13, wherein the processor is further configured to:
receive at least one query including at least one unknown promoter sequence of the microbial genome from a user; and
provide the query as an input to the at least one predictive model for predicting the at least one promoter subtype for the at least one unknown promoter sequence.

20. The electronic device of claim 19, wherein the processor is further configured to:
receive at least one query from the user including a Genbank file of the microbial genome;
extract at least one subsequence of the regulatory regions of the microbial genome from the GenBank file;
identify the at least one unknown promoter sequence from the extracted at least one subsequence; and
provide the at least one unknown promoter sequence as the input to the at least one predictive model for predicting the at least one promoter subtype for the at least one unknown promoter sequence.
